(19) United States
(12) Patent Application Publication
(10) Pub. No.: US 2013/0007291 A1
(43) Pub. Date: Jan. 3, 2013

(54) MEDIA INTERWORKING IN IPv4 AND IPv6 SYSTEMS

(75) Inventor: Matthew A. NICKOLS, Garland, TX (US)

(73) Assignee: Verrizon Patent and Licensing Inc., Basking Ridge, NJ (US)

(21) Appl. No.: 13/170,483

(22) Filed: Jun. 28, 2011

(51) Int. Cl. G06F 15/16

(52) U.S. Cl. 709/228

(57) ABSTRACT

A device receives a request, from a first endpoint device, to initiate a communication session with a second endpoint device. The device determines whether an IP version that is likely to be used by the second endpoint device, in establishing a media communication session, is compatible with the IP version used by the first endpoint device. The device transmits, when the determination is that the IP version likely to be used by the second endpoint device is compatible with the IP version used by first endpoint device, SIP messages to signal the establishment of a direct media communication session between the first and second endpoint devices. Otherwise, the device may transmit SIP messages to signal the establishment of the media communication session through an intermediary device.

### BACKGROUND

Voice over Internet Protocol (Voice over IP or VoIP) is one of a family of network technologies, communication protocols, and transmission technologies that enable the delivery of voice communications and multimedia sessions over IP networks, such as the Internet. When originating a VoIP session, a signaling operation may be performed between the parties to the VoIP session (often via an intermediary server) to setup the session. Based on the signaling, a media channel may be established between the parties. The media channel may be used to transmit the substantive data (e.g., the audio data) of the VoIP session.

Session Initiation Protocol (SIP) is a signaling protocol that is commonly used to perform the signaling for VoIP sessions. The protocol can be used for creating, modifying, and terminating two-party (unicast) or multiparty (multicast) sessions consisting of one or several media streams.

It can be problematic, in some situations, to establish VoIP sessions. For example, when the parties to a VoIP session are associated with networks using different protocols, such as a first party associated with an IPv4 (Internet Protocol version 4) network and a second party associated with an IPv6 (Internet Protocol version 6) network. IPv6 is a newer version of IPv4, in which the address space was increased from 32 to 128 bits. IPv6 is becoming increasingly popular as the limited number of unique addresses possible with IPv4 become exhausted. Unfortunately, IPv4 and IPv6 are not compatible with one another, and a direct media exchange between a party in an IPv4 network and a party in an IPv6 network may not be possible.

### BRIEF DESCRIPTION OF THE DRAWINGS

FIG. 1 is a diagram of an example environment in which systems and/or methods described herein may be implemented;

FIG. 2 is a diagram of example components of a device that may be used in the environment of FIG. 1;

FIG. 3 is a flow chart illustrating an example of a process for handling VoIP session requests with media interworking in IPv4 and IPv6 networks; and

FIGS. 4-10 are diagrams illustrating example communication flows relating to VoIP session requests with media interworking

### DETAILED DESCRIPTION OF PREFERRED EMBODIMENTS

The following detailed description refers to the accompanying drawings. The same reference numbers in different drawings may identify the same or similar elements.

Techniques described herein may relate to the interworking of IPv6 networks with IPv4 networks. Signaling for VoIP sessions may be performed using SIP. The SIP servers, when sending an offer for a VoIP session, such as a SIP INVITE message, may make a determination of whether the endpoints of the VoIP session use a compatible media session protocol, such as both using IPv4 or both using IPv6. When a SIP server believes the endpoints have compatible media session protocols, the SIP server may send a SIP message, which may include Session Description Protocol (SDP) information, to the destination endpoint without modifying the media session IP address and port that was provided by the origination endpoint. When the endpoints are determined not to be likely to use a compatible media session protocol or an error is generated when attempting to setup the media channel between two endpoints that are initially determined to be compatible, the SIP server may direct a media converter to act as an intermediary for the media channel. This may be accomplished by sending different SDP information, such as a different connection data IP address and a different media description port, to the destination endpoint. In this manner, the SIP server may act to intelligently route and/or handle the signaling for the VoIP session to allow direct media connections when the endpoints have compatible media session protocols and to engage a conversion device when the endpoints have incompatible media session protocols.

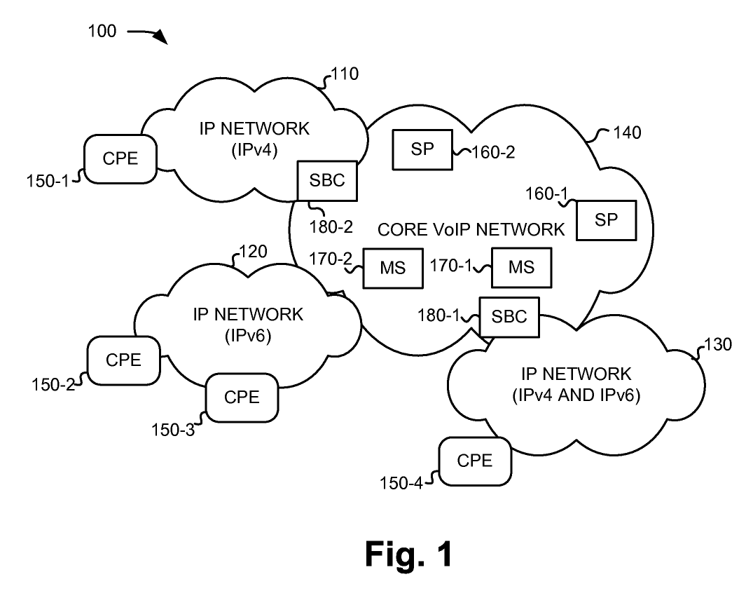

FIG. 1 is a diagram of an example environment 100 in which systems and/or methods described herein may be implemented. As illustrated, environment 100 may include a number of networks 110, 120, 130, and 140. Customer premise equipment (CPE) 150 may connect through one or more of networks 110, 120, and 130. Networks 110, 120, 130, and 140 may include multiple network devices that are used to implement networks 110, 120, 130, and 140. The network devices may particularly include SIP proxy servers (SPs) 160 (also called SIP servers 160 herein), media servers (MSs) 170, and session border controllers (SBCs) 180.

Networks 110, 120, and 130 may each include public or private (or both) IP network(s). Networks 110, 120, and 130, may be, for example, packet-based wide area networks (WANs), local area networks (LANs), or other types of networks. Networks 110, 120, and 130 may be based on IPv4 and/or IPv6. As illustrated in FIG. 1, network 110 may be an IPv4 network, network 120 may be an IPv6 network, and network 130 may be a mixed IPv4 and IPv6 network. Network 130 may include, for example, some network devices (e.g., routers) that are configured as IPv4 devices, some network devices that are configured as IPv6 devices, and some dual stack devices that have both IPv4 and IPv6 interfaces. In some situations, networks 110, 120, and/or 130 may include private networks, such as a network implemented by a customer of a telecommunications provider that manages core VoIP network 140. In other situations, networks 110, 120, and/or 130 may include public networks.

Network 140 may act as a core portion of the network that is used to provide VoIP services to CPE 150 that connect to networks 110, 120, and/or 130. Network 140 may include an IPv4 network, IPv6 network, and/or a combination of an IPv4 and IPv6 network. Network 140 may be operated by, for example, a telecommunications provider.

CPE 150-1 through 150-4 (referred to collectively as “CPE 150” and, in some instances, individually as “CPE 150”) may include any device that may be an endpoint in a VoIP session. CPE 150 may include, for instance, mobile devices, such as a personal digital assistant (PDA), a smart phone, a cellular phone, a tablet computer, etc. As mobile devices, CPE 150 may connect wirelessly to networks 110, 120, and/or 130. Additionally, CPE 150 may include fixed devices, such as fixed computers or fixed installations (e.g., SIP phones, IP private branch exchanges, and/or time division multiplex (TDM) to IP gateways). For example, a customer premise may include a residential home or business that connects to one of networks 110, 120, or 130. In some implementations, CPE 150 may connect directly to network 140.

As previously mentioned, VoIP services, such as audio services, may be provided in environment 100 using the SIP signaling protocol. The term VoIP (or VoIP service), as used herein, is intended to be interpreted broadly to cover audio services, video services, or multimedia services including, but not limited to, combinations of audio and video services. SIP servers 160-1 and 160-2 (referred to collectively as “SIP servers 160” and, in some instances, individually as “SIP server 160”) may act as SIP proxy servers to handle the SIP signaling. In general, SIP servers 160 may act as an intermediary entity for the purpose of making requests on behalf of other entities, such as CPE 150. SIP servers 160 may act to forward or route SIP messages to another entity “closer” to the endpoint CPE 150. SIP servers 160 may perform other functions, such as policy enforcement. The operation of SIP servers 160 will be described in more detail below.

MSs 170-1 and 170-2 (referred to collectively as “MSs 170” and, in some instances, individually as “MS 170”) may generally act to perform media processing, generation, and/or storage services for devices in environment 100. MSs 170 may include dual stack devices that include both IPv4 and IPv6 interfaces. In some situations, MSs 170 may act as an intermediary device. In particular, when acting as an intermediary between an IPv4 and IPv6 network, MSs 170 may function to convert incoming IPv4 packets to outgoing IPv6 packets and/or convert incoming IPv6 packets to outgoing IPv4 packets. MSs 170 may act as media converters in which media packets (i.e., packets that are part of the substantive real-time transport protocol (RTP) traffic for a VoIP session) may be converted between IPv4 and IPv6 networks.

SBCs 180-1 and 180-2 (referred to collectively as “SBCs 180” and, in some instances, individually as “SBC 180”) may generally provide functions relating to network topology hiding and network address translation (NAT) traversal. As with MSs 170, SBCs 180 may include dual stack devices that include both IPv4 and IPv6 interfaces. When acting as an intermediary between an IPv4 and IPv6 network, SBCs 180 may function to convert incoming IPv4 packets to outgoing IPv6 packets and/or convert incoming IPv6 packets to outgoing IPv4 packets. SBCs 180 may act as media converters in which media packets (i.e., packets that are part of the substantive real-time transport protocol (RTP) traffic for a VoIP session) may be converted between IPv4 and IPv6 networks.

Although FIG. 1 shows example components of environment 100, in other implementations, environment 100 may contain fewer components, different components, differently arranged components, and/or additional components than those depicted in FIG. 1. Alternatively, or additionally, one or more components of environment 100 may perform one or more other tasks described as being performed by one or more other components of environment 100. Further, although FIG. 1 and the components of FIG. 1 were discussed with reference to the SIP protocol, in alternative implementations, signaling protocols other than SIP may be used.

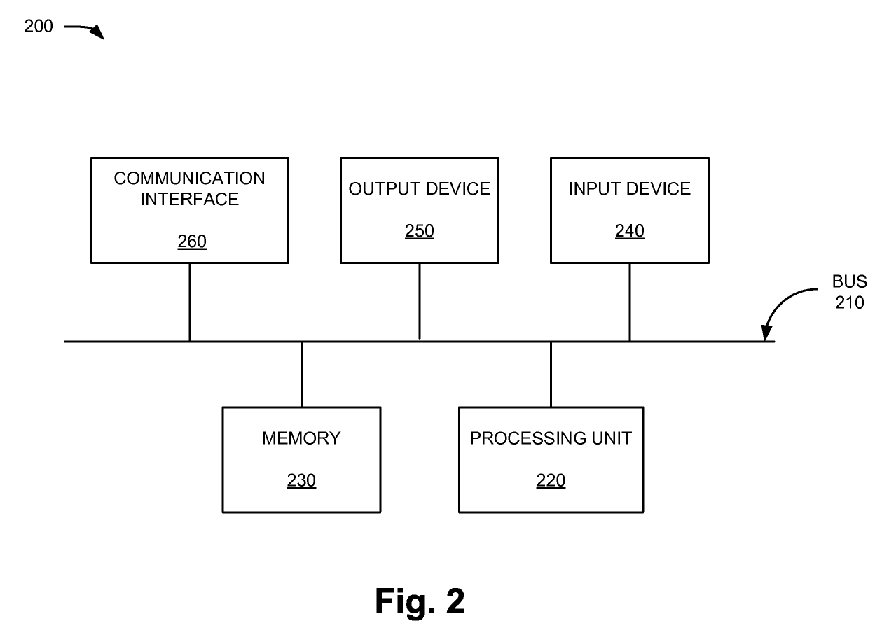

FIG. 2 is a diagram of example components of a device 200 that may correspond to one of the components shown in environment 100, such as CPE 150, a device in CPE 150, SIP server 160, MS 170, and/or an SBC 180. As illustrated, device 200 may include a bus 210, a processing unit 220, a memory 230, an input device 240, an output device 250, and a communication interface 260.

Bus 210 may permit communication among the components of device 200. Processing unit 220 may include one or more processors or microprocessors that interpret and execute instructions. Additionally or alternatively, processing unit 220 may be implemented as or include one or more application specific integrated circuits (ASICs), field programmable gate arrays (FPGAs), or the like.

Memory 230 may include a random access memory (RAM) or another type of dynamic storage device that stores information and instructions for execution by processing unit 220, a read only memory (ROM) or another type of static storage device that stores static information and instructions for the processing unit 220, and/or some other type of magnetic or optical recording medium and its corresponding drive for storing information and/or instructions.

Input device 240 may include a device that permits an operator to input information to device 200, such as a keyboard, a keypad, a mouse, a pen, a microphone, one or more biometric mechanisms, and the like. Output device 250 may include a device that outputs information to the operator, such as a display, a speaker, etc.

Communication interface 260 may include any transceiver-like mechanism that enables device 200 to communicate with other devices and/or systems. For example, communication interface 260 may include mechanisms for communicating with other devices, through either a wired or wireless interface.

As described herein, device 200 may perform certain operations in response to processing unit 220 executing software instructions contained in a computer-readable medium, such as memory 230. A computer-readable medium may be defined as a non-transitory memory device. A memory device may include space within a single physical memory device or spread across multiple physical memory devices. The software instructions may be read into memory 230 from another computer-readable medium or from another device via communication interface 260. The software instructions contained in memory 230 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows example components of device 200, in other implementations, device 200 may contain fewer components, different components, differently arranged components, or additional components than depicted in FIG. 2. Alternatively, or additionally, one or more components of device 200 may perform one or more tasks described as being performed by one or more other components of device 200.

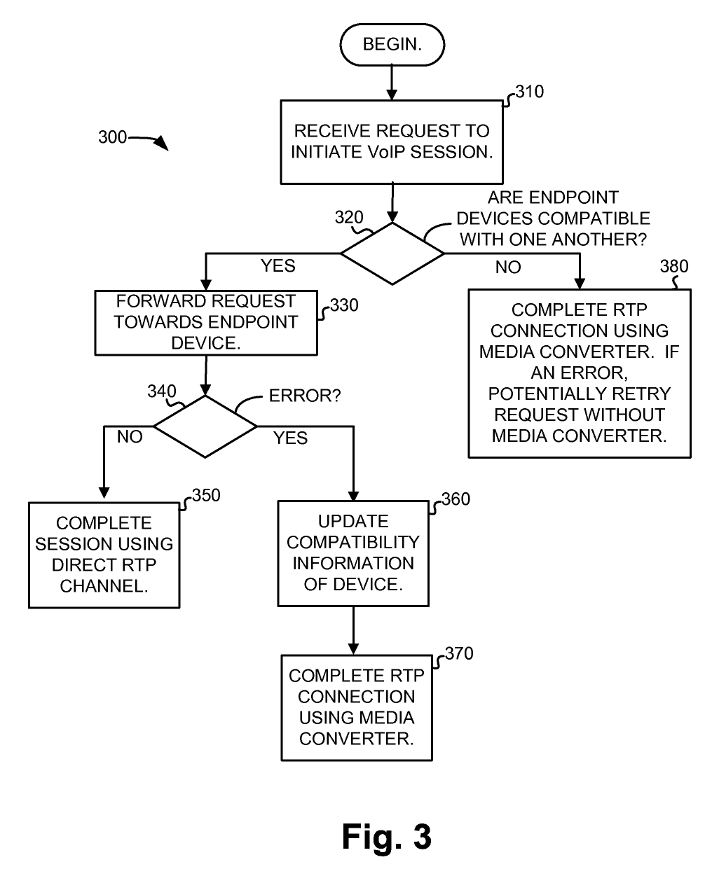

FIG. 3 is a flow chart illustrating an example of a process 300 for handling VoIP session requests with media interworking in IPv4 and IPv6 networks. Process 300 may be performed by, for example, one or more of SIP servers 160.

Process 300 may include receiving a request to initiate a VoIP session (block 310). A VoIP session may include, for example, an audio call. The request may be received by one of SIP servers 160 as a SIP message, such as a SIP INVITE message, that includes an identification of the destination device as well as other information relating to the VoIP session. For example, the SIP INVITE message may include SDP information that provides information relating to how the endpoint device that is providing the SDP offer desires to establish the RTP connection (i.e., the substantive connection over which the media for the VoIP session is transferred) for the VoIP session. The SDP information may include, for example, fields specifying a codec to use for the VoIP session, a connection data IP address to which to connect, a media description port, or other information relating to the substantive RTP connection. The request may be initiated by one CPE 150 and destined for another CPE 150. CPE 150 may be using the same or different network protocols. For example, CPE 150-1, which may be an IPv4 device, may originate a VoIP call with CPE 150-2, which may be an IPv6 device. Also as an example, CPE 150-1 may be a device that sends SIP messages via IPv4 packets, but contained in the SIP message may be IPv6 addresses, or vice versa, such that the layer 3 of the SIP signaling messages does not necessarily reflect the protocol that will be used for sending and/or receiving media.

Process 300 may further include determining whether the destination endpoint device, of the VoIP session, is compatible with the originating endpoint device (block 320). Two devices may be compatible when both support IPv4 media, when both support IPv6 media, or when both are connected to networks that are compatible. Alternatively, compatibility may be based on the set of protocols supported by the endpoints. The decision of block 320 may be made by a SIP server 160 based on, for example, provisioned information in the SIP server, based on learned information that is obtained during prior interaction of SIP server 160 with a device, based on policy information, or based on some other information. In general, SIP server 160 may determine whether the IP version that is likely to be used by the destination endpoint device, for an RTP communication session (i.e., the media session), is compatible with the IP version that is used by the originating endpoint device. In some situations, SIP sever 160 may not be able to determine, or have no knowledge of, the media compatibility of the endpoint devices. In this case, SIP server 160 may initially assume that the devices are compatible.

When the endpoint devices are determined or assumed to be compatible with one another, (block 320—YES), the offer for the VoIP session may be forwarded towards the destination endpoint (block 330). In this situation, the request, such as the SIP INVITE message, may include SDP information that can be successfully used by the destination endpoint to create the RTP connection.

Process 300 may further include determining if there was an error associated with the request sent in block 330 (block 340). For a SIP message, for example, if the SDP information specifies an IPv4 media stream and the destination endpoint only supports IPv6 media streams, the destination endpoint may return a SIP 488 error (Not Accepted Here) error code. In some implementations, only certain errors (such as SIP 488 errors or other errors that relate to media compatibility processing) may be detected in block 340. Other types of errors, which may not result in further media compatibility processing, may be acted upon in other ways, such as by terminating the VoIP session.

If no error is detected, (block 340—NO), the VoIP session may complete by directly establishing the RTP channel between the endpoints (block 350). For example, the two endpoint CPEs 150, such as CPE 150-1 and 150-4 (which may both be support media via IPv4), may directly connect to one another and establish the RTP channel over which the substantive media, such as the audio for a telephone call, is transferred.

When an error is detected, (block 340—YES), process 300 may include updating compatibility information at SIP server 160. For example, the SIP server 160 may receive a SIP 488 error after sending an INVITE message, that includes an invitation to create an IPv4 RTP channel. SIP server 160 may update an internal data structure to indicate that the corresponding destination endpoint does not accept IPv4 RTP connections. In some implementations, block 360 may be omitted.

Process 300 may further include completing the RTP connection using a media converter (block 370). A media converter, as used herein, may refer to a dual stack network device that can translate a media stream between IPv4 and IPv6 (or vice versa). MS 170 or SBC 180 may, for example, act as media converters. In one implementation, completing the media RTP connection using the media converter may include modifying the SDP offer and SDP answer to include SDP information corresponding to the media converter. The originating and destination endpoints may then send and receive media via the media converter, which may act as an intermediary entity between the two endpoints.

Referring back to block 320, when the endpoint devices are determined or assumed not to be compatible with one another (block 320—NO), the media RTP connection may be completed using a media converter (block 380). The operation performed in block 380 may be similar to that performed in block 370. In some situations, the signaling to use a media converter may itself result in an error. In this case, SIP server 160 may try to establish the VoIP session using, for example, a direct RTP channel between the endpoints.

Through the operation of process 300, VoIP sessions may be intelligently routed and completed in mixed IPv4 and IPv6 networks. Sessions that need to be completed through a media converter may be routed to the media converter. Sessions that do not need to be routed through the media converter or sessions in which this information is not known may be initially attempted using a direct connection between the endpoints. “Pinning” or “anchoring” all RTP connection through a media converter, whether or not media conversion is required, can cause a traffic burden on the network. With the technique of process 300, sessions that need media conversion can be routed through the media converter while sessions that do not need media conversion can be directly connected.

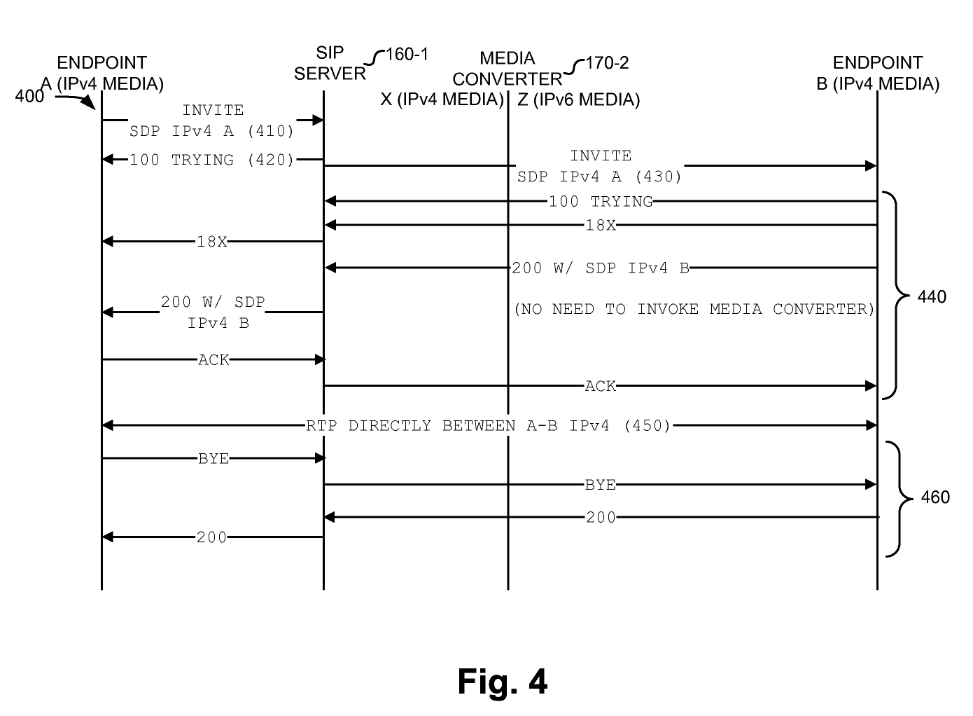

FIG. 4 is a diagram illustrating an example communication flow 400 for a VoIP session established without invoking a media converter. Communication flow 400 may correspond to the block flow: block 310, block 320, block 330, block 340, and block 350 (FIG. 3).

In FIG. 4, assume that a first endpoint device (ENDPOINT A) wishes to establish a VoIP session with a second endpoint device (ENDPOINT B). Both endpoint devices A and B may devices that are capable of establishing an IPv4 RTP connection. Endpoint A may transmit an INVITE message to a SIP server, such as SIP server 160-1 (communication 410). The INVITE message may include SDP information indicating that endpoint A is capable of an IPv4 RTP connection. SIP server 160-1 may respond with a 100 TRYING message (communication 420). SIP server 160-1 may determine that endpoint B is (or may be) an IPv4 endpoint and may send the INVITE message to endpoint B (communication 430).

Endpoint A and endpoint B may continue to communicate, through SIP server 160-1, in preparation for setting up the IPv4 RTP connection between endpoints A and B (communications 440). Communications 440 may particularly include endpoint B returning SDP information to endpoint A, including the IPv4 media address of endpoint B that is to be used for the IPv4 RTP connection. Because endpoints A and B are both using IPv4 for their media, there may be no need to invoke a media converter. Endpoints A and B may establish the RTP connection (communication 450). At the conclusion of the RTP session, endpoints A and B may again communicate, with SIP server 160-1, to terminate the VoIP session (communications 460).

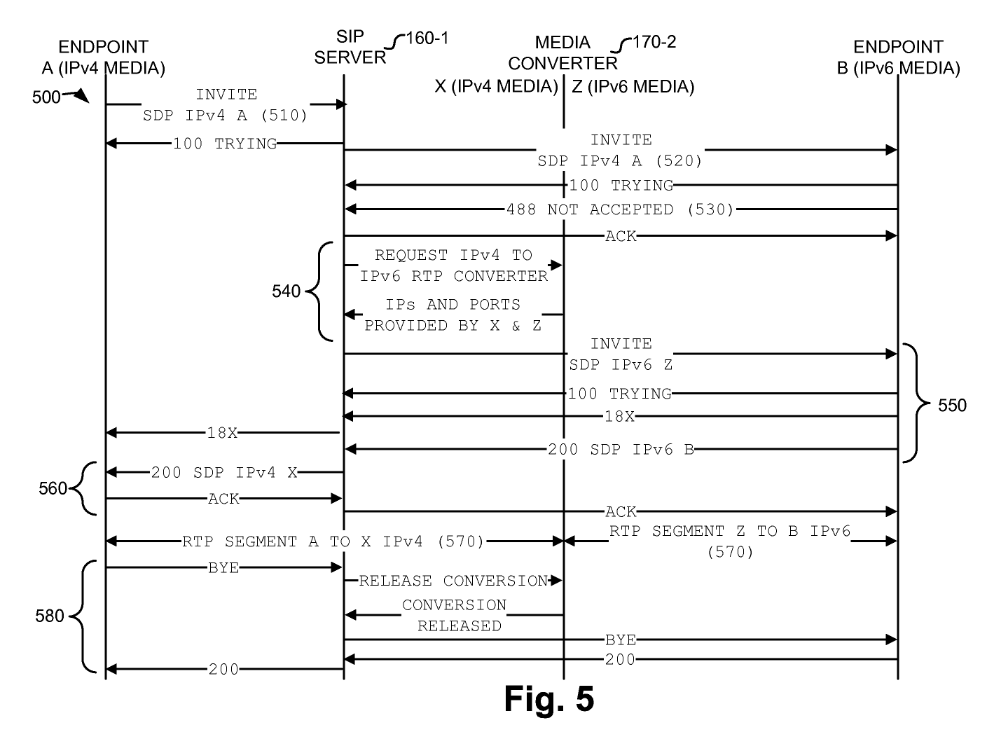

FIG. 5 is a diagram illustrating an example communication flow 500 for a VoIP session established through a media converter after reception of an error message. Communication flow 500 may correspond to the block flow: block 310, block 320, block 330, block 340, and block 370 (FIG. 3).

In FIG. 5, as with FIG. 4, endpoint A may wish to establish a VoIP session with endpoint B, using SIP server 160-1. Endpoint A may support media via IPv4 and endpoint B may support media via IPv6. A media converter, which may correspond to MS 170-2, may act as an intermediary between the IPv4 and IPv6 networks.

Endpoint A may transmit an INVITE message to SIP server 160-1 (communication 510). The INVITE message may include SDP information indicating that endpoint A is capable of an IPv4 RTP connection. SIP server 160-1 may determine that endpoint B is (or may be) an endpoint capable of an IPv4 RTP connection and may forward the INVITE message to endpoint B (communication 520). Endpoint B may receive the INVITE message and respond with a SIP 488 error, potentially indicating that the IPv4 RTP connection is not supported (communication 530). Based on the error, SIP server 160-1 may assume that endpoint B requires an IPv6 RTP connection. Accordingly, SIP server 160-1 may signal media converter 170-2 to request conversion between an IPv4 and IPv6 RTP connection (communications 540). As part of the communications with media converter 170-2, media converter 170-2 may inform SIP server 160-1 of the IP addresses and ports corresponding to the IPv4 interface (interface X) and the IPv6 interface (interface Z), of media converter 170-2, and at which endpoint A and endpoint B are to connect.

SIP server 160-1 may communicate the information relating to the Z interface of media converter 170-2 to endpoint B (communications 550) and may communicate the information relating to the X interface of media converter 170-2 to endpoint A (communications 560). Endpoints A and B may then establish the RTP connection through media converter 170-2 (communications 570). At the conclusion of the RTP session, SIP signaling may be used to end the session between endpoint A, SIP server 160-1, media converter 170-2, and endpoint B (communications 580).

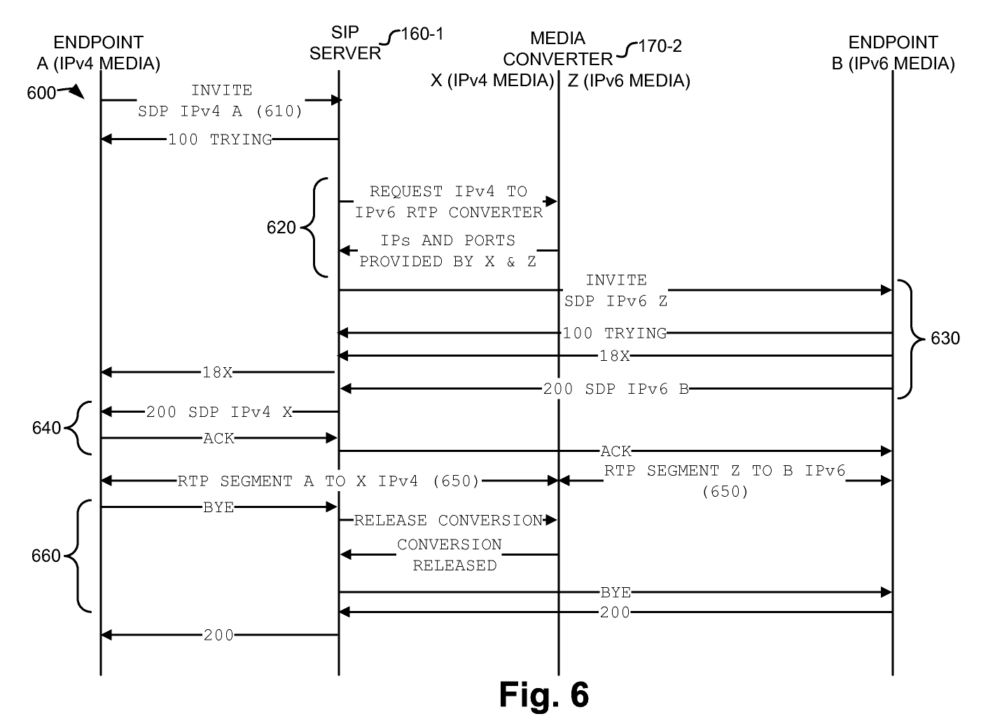

FIG. 6 is a diagram illustrating an example communication flow 600 for a VoIP session that is initially established through a media converter. Communication flow 600 may correspond to the block flow: block 310, block 320, and block 380 (FIG. 3).

In FIG. 6, as with FIG. 5, endpoint A may wish to establish a VoIP session with endpoint B, using SIP server 160-1. Endpoint A may support media via IPv4 and endpoint B may support media via IPv6. A media converter, which may correspond to MS 170-2, may act as an intermediary between the IPv4 and IPv6 networks.

Endpoint A may transmit an INVITE message to SIP server 160-1 (communication 610). The INVITE message may include SDP information indicating that endpoint A is capable of an IPv4 RTP connection. SIP server 160-1 may determine that endpoint B is an IPv6 endpoint that is not capable of an IPv4 RTP connection. For example, SIP server 160-1 may include provisioning information indicating that endpoint B is an IPv6 endpoint or SIP server 160-1 may have learned, during a prior interaction with endpoint B, that endpoint B is an IPv6 endpoint. Accordingly, SIP server 160-1 may signal media converter 170-2 to request conversion between an IPv4 and an IPv6 RTP connection (communications 620). As part of the communications with media converter 170-2, media converter 170-2 may signal the IP addresses and ports corresponding to the IPv4 interface (interface X) and the IPv6 interface (interface Z).

SIP server 160-1 may communicate the information relating to the Z interface of media converter 170-2 to endpoint B (communications 630) and may communicate the information relating to the X interface of media converter 170-2 to endpoint A (communications 640). Endpoints A and B may then establish the RTP connection through media converter 170-2 (communications 650). At the conclusion of the RTP session, SIP signaling may be used to end the session between endpoint A, SIP server 160-1, media converter 170-2, and endpoint B (communications 660).

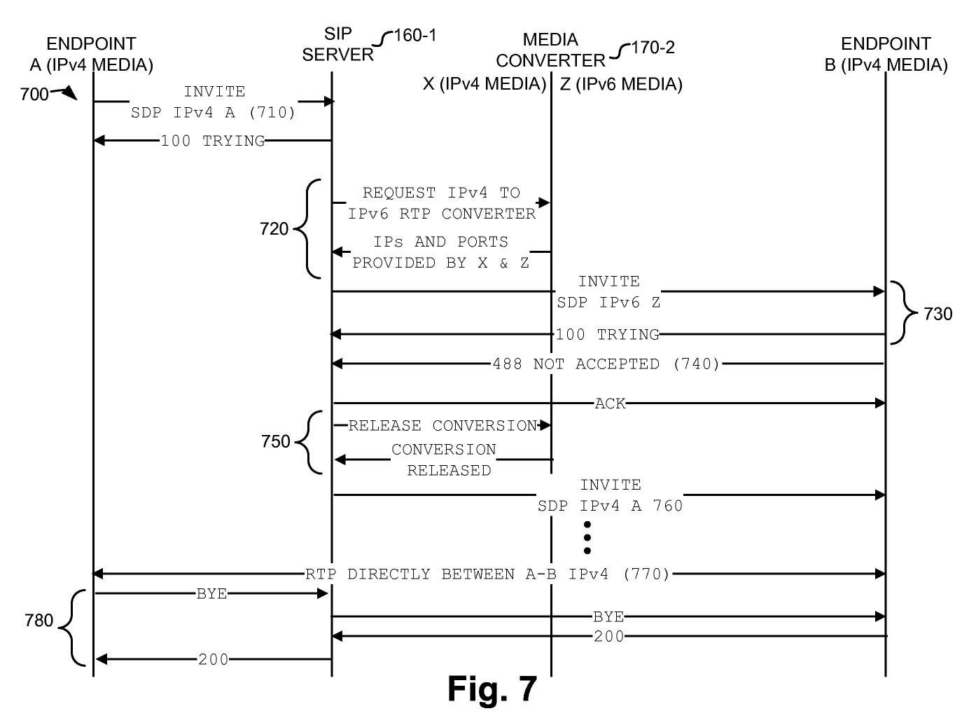

FIG. 7 is a diagram illustrating an example communication flow 700 for a VoIP session that is initially attempted through a media converter but in which media converter is not needed. Communication flow 700 may correspond to the block flow: block 310, block 320, and block 380 (FIG. 3).

In FIG. 7, as with FIG. 6, endpoint A may wish to establish a VoIP session with endpoint B, using SIP server 160-1. Endpoints A and B may support media via IPv4.

Endpoint A may transmit an INVITE message to SIP server 160-1 (communication 710). The INVITE message may include SDP information indicating that endpoint A is capable of an IPv4 RTP connection. In this example, assume that SIP server 160-1 determines that endpoint B is not capable of an IPv4 RTP connection. For example, SIP server 160-1 may include provisioning information indicating that endpoint B supports media via IPv6 or SIP server 160-1 may have learned, during a prior interaction with endpoint B, that endpoint B supports media via IPv6. However, assume that, at some point, endpoint B may have been converted such that it now supports media via IPv4 or endpoint B may support multiple media processors in which some are IPv4 and some are IPv6.

SIP server 160-1 may signal media converter 170-2 to request conversion between an IPv4 and IPv6 RTP connection (communications 720). SIP server 160-1 may communicate the information relating to the IPv6 Z interface of media converter 170-2 to endpoint B (communications 730). Because endpoint B includes an IPv4 interface and the INVITE message specifies IPv6 SDP information, endpoint B may respond with an error code (communication 740). The conversion with media converter 170-2 may then be terminated (communications 750).

Because SIP server 160-1 has not tried an IPv4 media connection with endpoint B, SIP server 160-1 may respond to the error message from endpoint B by inviting endpoint B to an IPv4 RTP connection with endpoint A (communication 760). Endpoints A and B may then directly establish the RTP connection with one another (communications 770). At the conclusion of the RTP session, SIP signaling may be used to end the session between endpoint A, SIP server 160-1, media converter 170-2 and endpoint B (communications 780).

In communication flow 700, SIP server 160-1 may incorrectly determine that endpoint B was an IPv6 endpoint. SIP server 160-1, however, may still be able to assist endpoints A and B in establishing a direct IPv4 RTP connection.

In some situations, endpoints or networks devices may be provisioned, such as by network operators, to restrict the media choice (e.g., IPv4 or IPv6 ) that can be used by a particular device. In this case, SIP server 160-1 may always attempt to use the restricted media choice. In case of an error with use of the restricted media choice, the VoIP session may be rejected rather than reattempted with a media choice that is not allowed by the restrictions.

In some situations, a device may generate SDP information in which the device offers different types of media connections. For example, an endpoint in a dual IPv4/IPv6 network may indicate, in the SDP information, that it accepts both IPv4 RTP connections and IPv6 RTP connections. The other endpoint may thus choose which RTP connection to use. This may be referred to as “dual offer” herein. One potential disadvantage of including a dual offer in SIP SDP information is that the receiving endpoint may not understand the format and may generate an error message.

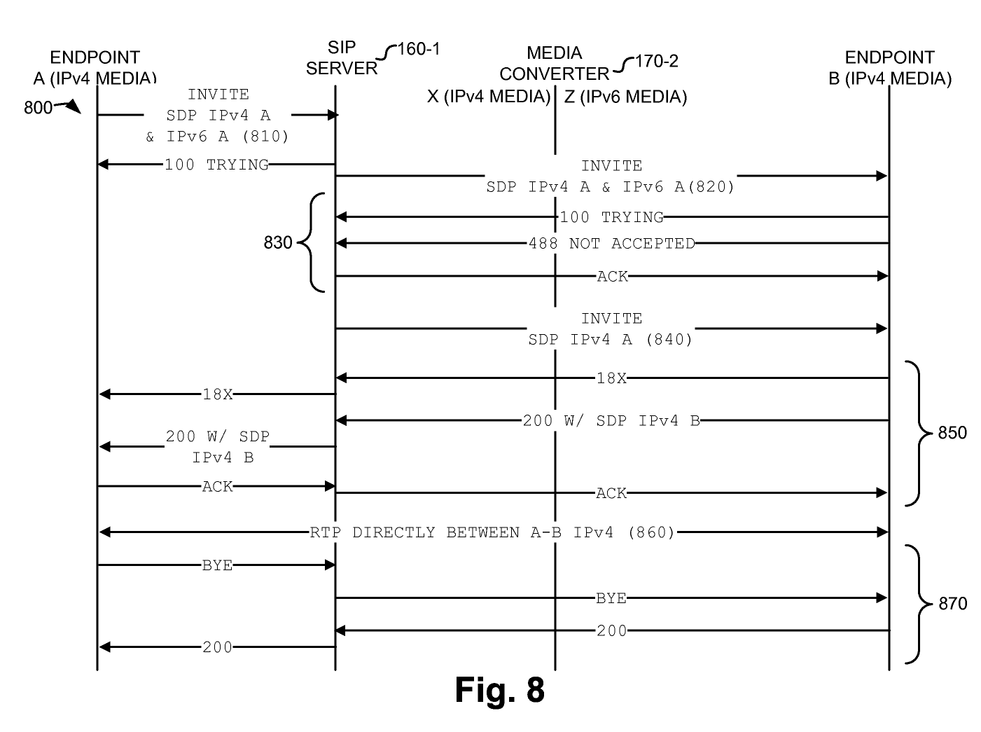

FIG. 8 is a diagram illustrating an example communication flow 800 for a VoIP session in which a dual offer is presented but not recognized by the receiving endpoint. In FIG. 8, as with FIG. 7, endpoint A may wish to establish a VoIP session with endpoint B, using SIP server 160-1. Endpoints A and B may be IPv4 devices. Endpoint A may be capable of providing dual offer information within SDP information. Endpoint B may be, for example, an older device that does not support dual offer.

Endpoint A may transmit an INVITE message to SIP server 160-1 (communication 810). The INVITE message may include dual offer SDP information indicating that endpoint A is capable of an IPv4 RTP connection or an IPv6 RTP connection. Endpoint B may not be able to parse the format of the dual offer, and may issue an error message (communication 830). In this case, SIP server 160-1 may determine that the dual offer format may have been the likely cause of the error, and may accordingly reformat the dual offer into a more conventional single offer format. SIP server 160-1 may then transmit an INVITE message, including an offer for a single IPv4 RTP connection, to endpoint B (communication 840). Endpoint B may accept the new INVITE message, which may cause SIP server 160-1 to forward SDP information, including the IPv4 information of endpoint B, to endpoint A (communications 850).

Endpoints A and B may then directly establish the IPv4 RTP connection with one another (communication 860). At the conclusion of the RTP session, SIP signaling may be used to end the session between endpoint A, SIP server 160-1, and endpoint B (communications 870).

As an alternative situation to that shown in FIG. 8, assume that a dual offer is issued by endpoint A, but endpoint B is restricted (e.g., during provisioning) to only accept IPv4 or only accept IPv6 media connections. In this case, SIP server 160-1 may reformat the SDP information, to remove the undesired portion of the dual offer, before forwarding the INVITE message to endpoint B.

In another alternative situation, assume that a single offer is received from endpoint A, but that endpoint B has been provisioned to only receive dual offers or SIP server 160-1 has learned that endpoint B is capable of processing dual offers. SIP server 160-1 may reformat the SDP information to include dual offer information before forwarding it to endpoint B. If endpoint B responds by accepting the RTP connection that corresponds to the IP protocol that is not supported by endpoint A, SIP server 160-1 may use media converter 170-2 to complete the VoIP session. Otherwise, if endpoint B responds by accepting the RTP connection that corresponds to the IP protocol that is supported by endpoint A, endpoints A and B may form a direct RTP connection.

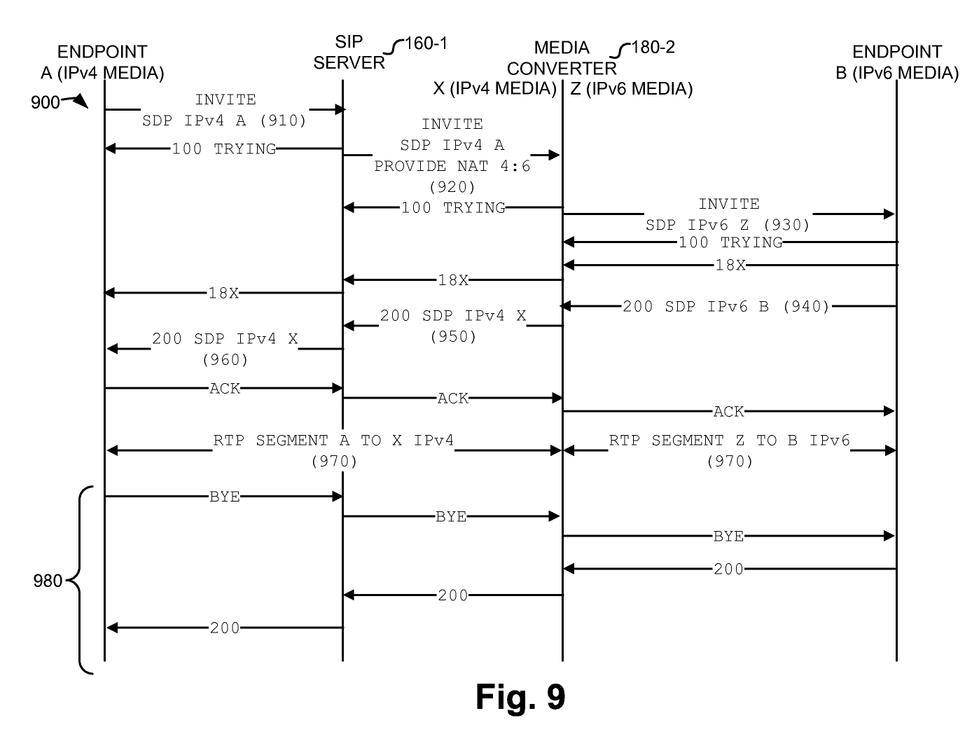

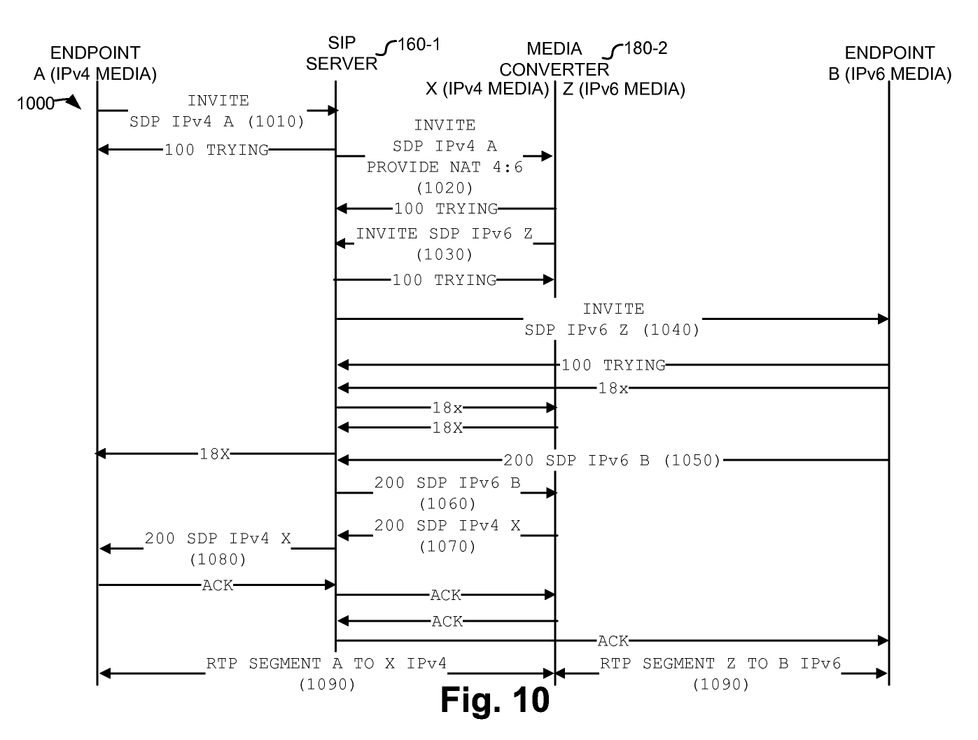

In the description of FIGS. 4-8, MSs 170 were discussed as being used as the media converter. In alternative implementations, SBCs 180 could function as a media converter. Examples of using SBCs 180 as a media converter will next be discussed with reference to FIGS. 9 and 10.

FIG. 9 is a diagram illustrating an example communication flow 900 for a VoIP session established through a media converter. Communication flow 900 may correspond to the block flow: block 310, block 320, and block 380 (FIG. 3).

In FIG. 9, endpoint A may wish to establish a VoIP session with endpoint B, using SIP server 160-1. Endpoint A may only support media via IPv4 and endpoint B may only support media via IPv6. A media converter, which may correspond to SBC 180-2, may act as an intermediary between IPv4 and IPv6 networks.

Endpoint A may transmit an INVITE message to SIP server 160-1 (communication 910). The INVITE message may include SDP information indicating that endpoint A is capable of an IPv4 RTP connection. SIP server 160-1 may determine that endpoint B is an IPv6 endpoint that is not capable of an IPv4 RTP connection. In response, SIP server 160-1 may signal media converter 180-2, via an INVITE message, to provide network address translation (NAT) services between IPv4 and IPv6 devices (communication 920). Indication that NAT services are required may not actually be signaled in the message from the SIP server 160-1 to the media converter 180-2. As an alternative, the media converter 180-2 may have static configuration and/or other logic that simply results in the conversion functions taking place. The INVITE message may include SDP information that includes the IPv4 address of endpoint A for the media connection. Media converter 180-2 may correspondingly send an INVITE message to endpoint B including the IPv6 interface (interface Z) of media converter 180-2 (communication 930). Endpoint B may respond with its IPv6 interface (interface B) (communication 940). Media converter 180-2 may, in response, send SDP information, including the X interface of media converter 180-2, to SIP server 160-1 (communication 950). The SIP server 160-1 may, in response, send SDP information, including the X interface of media converter 108-2, to endpoint A (communications 960).

Endpoints A and B may then establish the RTP connection through media converter 180-2 (communications 970). At the conclusion of the RTP session, SIP signaling may be used to end the session between endpoint A, SIP server 160-1, media converter 180-2, and endpoint B (communications 980).

FIG. 10 is a diagram illustrating an example communication flow 1000 for a VoIP session established through a media converter. Communication flow 1000 may correspond to the block flow: block 310, block 320, and block 380 (FIG. 3). Communication flow 1000 may be similar to communication flow 900, except that instead of media converter 180-2 transmitting SDP information to endpoint B, media converter 180-2 may transmit this information back to SIP server 160-1, which may then send the SDP information to endpoint B.

In FIG. 10, endpoint A may wish to establish a VoIP session with endpoint B, using SIP server 160-1. Endpoint A may be an IPv4 device and endpoint B may be an IPv6 device. A media converter, which may correspond to SBC 180-2, may act as an intermediary between IPv4 and IPv6 networks.

Endpoint A may transmit an INVITE message to SIP server 160-1 (communication 1010). The INVITE message may include SDP information indicating that endpoint A is capable of an IPv4 RTP connection. SIP server 160-1 may determine that endpoint B is an IPv6 endpoint that is not capable of an IPv4 RTP connection. In response, SIP server 160-1 may signal media converter 180-2, via an INVITE message, to provide network address translation (NAT) between IPv4 and IPv6 devices (communication 1020). Indication that NAT services are required may not actually be signaled in the message from the SIP server 160-1 to the media converter 180-2. As an alternative, the media converter 180-2 may have static configuration and/or other logic that simply results in the conversion functions taking place. The INVITE message may include SDP information that includes the IPv4 address of endpoint A for the media connection. Media converter 180-2 may subsequently send an INVITE to SIP server 160-1 with the IPv6 interface (interface Z) of media converter 180-2 (communication 1030). SIP server 160-1 may then send the interface information, received in communication 1030, to endpoint B as an INVITE message (communication 1040).

Endpoint B may respond, to SIP server 160-1, to the INVITE message by returning SDP information, that includes its IPv6 media interface (interface B) (communication 1050). SIP server 160-1 may send the IPv6 interface information to media converter 180-2 (communication 1060), which may subsequently respond to the SIP server 160-1 with the IPv4 media interface (interface X) information (communication 1070). The SIP server 160-1 may subsequently respond to endpoint A with the IPV4 media interface (interface X) of the media converter 180-2 (communication 1080).

Endpoints A and B may then establish the RTP connection through media converter 180-2 (communications 1090). Although not shown in FIG. 10, at the conclusion of the RTP session, SIP signaling may be used to end the session between endpoint A, SIP server 160-1, media converter 180-2, and endpoint B.

Although media converters were generally discussed above as being MSs 170 or SBCs 180, in other possible implementations, the function of the media converter can be performed by other network devices. For example, servers dedicated to performing media conversion functions may be used. Further, SIP server 160-1 may engage the services of a media converter in a number of possible ways. For example, a query/response message to another network element, such as a network address translation (NAT) device, may be used to obtain the corresponding IPv4 and IPv6 interface addresses of the media converter (e.g., interfaces “X” and “Z” in FIGS. 4-8). Additionally or alternatively, a dedicated media control protocol may be used to control the media converters. Additionally or alternatively, for enhanced security, SIP server 160-1 may inform the media converter of the addresses of the endpoints from which RTP connections are expected.

Although the above description was generally given with respect to IPv4, IPv6, SIP, and RTP, other protocols could alternatively be used. Further, although VoIP sessions were generally described above, other services (e.g., video services) could be similarly initiated. Further, although SIP servers 160 were described above as performing intelligent routing of SIP messages, other devices may perform some or all of the functions described as being performed by SIP servers 160.

The foregoing description of implementations provides illustration and description, but is not intended to be exhaustive or to limit the invention to the precise form disclosed. Modifications and variations are possible in light of the above teachings or may be acquired from practice of the invention.

For example, while a series of blocks has been described with regard to FIG. 3, the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

The term “component,” as used herein, is intended to be broadly construed to include hardware (e.g., a processor, a microprocessor, an ASIC, a FPGA, a chip, a memory device (e.g., a ROM, a RAM, etc.), etc.) or a combination of hardware and software (e.g., a processor, microprocessor, ASIC, etc. executing software contained in a memory device).

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method implemented by a device, the method comprising:
receiving a request, by the device and from a first endpoint device, to initiate a media communication session with a second endpoint device;
determining, by the device, whether an Internet Protocol (IP) version that is likely to be used by media resources of the second endpoint device, for the media communication session, is compatible with the IP version that is used by media resources of the first endpoint device;
transmitting, by the device, one or more session initiation protocol (SIP) messages to signal the establishment of a direct media communication session between the first and second endpoint devices, when the determination is that the IP version that is likely to be used by the media resources of the second endpoint device is compatible with the IP version that is used by the media resources of the first endpoint device; and
transmitting, by the device, one or more second SIP messages to signal the establishment of the media communication session through an intermediary device, when the determination is that the IP version that is likely to be used by the media resources of the second endpoint device, in establishing the media communication session, is not compatible with the IP version that is used by the media resources of the first endpoint device.

2. The method of claim 1, further including, in response to transmitting the one or more SIP messages:
receiving a SIP error message from the second endpoint device; and
transmitting, after receipt of the SIP error message, one or more third messages to signal the establishment of the media communication session through the intermediary device.

3. The method of claim 1, further including, in response to transmitting the second one or more SIP messages:
receiving a SIP error message from the second endpoint device; and
transmitting, after receipt of the SIP error message, one or more third messages to signal the establishment of the direct media communication session between the first and second endpoint devices.

4. The method of claim 1, where determining the IP version that is likely to be used by the second endpoint device includes:
determining whether the media resources of the second endpoint device are likely to use IP version four or IP version six.

5. The method of claim 1, where determining the IP version that is likely to be used by media resources of the second endpoint device includes:
performing the determination based on at least one of provisioned information in the device, historical information learned by the device, or policy information.

6. The method of claim 1, where the communication session includes a voice over internet protocol (VoIP) communication session.

7. The method of claim 1, further comprising:
determining whether the received request includes a dual offer; and
modifying the request, to include a single offer, when the request includes a dual offer and the second endpoint device is determined to not be capable of processing dual offer requests.

8. The method of claim 1, further comprising:
determining whether the received request includes a single offer; and
modifying the request, to include a dual offer, when the request includes a single offer and the second endpoint device is determined to be capable of processing dual offer requests.

9. The method of claim 1, where the device acts as a SIP proxy server.

10. The method of claim 1, where the media communication session includes a real-time transport protocol (RTP) session.

11. The method of claim 1, further comprising:
determining whether the second endpoint device based on provisioning information has been restricted to only use certain media types or has been restricted to use either a direct media communication session or a media communication session implemented through an intermediary device; and
transmitting the one or more SIP messages or the second one or more SIP messages based on the determination of whether the second endpoint device is provisioned to be restricted.

12. A device comprising:
a processor; and
a memory to store programming instructions that, when executed by the processor, cause the processor to:
receive a request, from a first endpoint device, to initiate a communication session with a second endpoint device;
determine whether an Internet Protocol (IP) version that is likely to be used by media resources of the second endpoint device, in establishing a media communication session, is compatible with the IP version that is used by media resources of the first endpoint device;
transmit one or more session initiation protocol (SIP) messages to signal the establishment of a direct media communication session between the first and second endpoint devices, when the determination is that the IP version that is likely to be used by the media resources of the second endpoint device is compatible with the IP version that is used by the media resources of the first endpoint device; and
transmit one or more second SIP messages to signal the establishment of the media communication session through an intermediary device, when the determination is that the IP version that is likely to be used by the media resources of the second endpoint device is not compatible with the IP version that is used by the media resources of the first endpoint device.

13. The device of claim 12, where the intermediary device includes a dual stack network device.

14. The device of claim 12, where the intermediary device includes a session border controller network device, media server, or network address translation (NAT) device.

15. The device of claim 12, where the device includes a SIP proxy server.

16. The device of claim 12, where the programming instructions additionally include programming instructions that, when executed by the processor, cause the processor to:
receive a SIP error message from the second endpoint device; and
transmit, in response to the SIP error message, one or more third messages to signal the establishment of the media communication session through the intermediary device.

17. The device of claim 12, where the programming instructions additionally include programming instructions that, when executed by the processor, cause the processor to:
receive a SIP error message from the second endpoint device; and
transmit, in response to the SIP error message, one or more third messages to signal the establishment of the direct media communication session between the first and second endpoint devices.

18. The device of claim 12, where the determination of the IP version that is likely to be used by the second endpoint device is based on at least one of provisioned information in the device, historical information learned by the device, or policy information.

19. The device of claim 12, where the communication session includes a voice over internet protocol (VoIP) communication session.

20. A system comprising:
a media converter, that includes a dual network stack, to convert media communication sessions between an Internet Protocol version 4 (IPv4) interface and an Internet Protocol version 6 (IPv6 ) interface; and
a server to route session initiation protocol (SIP) messages as part of setting up of a media communication session between a first endpoint device and a second endpoint device, the server to:
receive a request, from the first endpoint device, to initiate a communication session with the second endpoint device;
transmit, in response to the request, one or more SIP messages to signal the establishment of a direct media communication session between the first and second endpoint devices;
receive, in response to the transmitted one or more SIP messages, an error message from the second endpoint device; and
transmit, in response to the received error message, one or more second SIP messages to signal the establishment of a media communication session, between the first and second endpoint devices, through the media converter.

21. The system of claim 20, where the error message includes a SIP 488 message.

22. The system of claim 20, where the communication session includes a voice over internet protocol (VoIP) communication session.

23. The system of claim 20, where the server is further to:
determine whether an Internet Protocol (IP) version that is likely to be used by media resources of the second endpoint device, in establishing the media communication session, is compatible with the IP version that is used by media resources of the first endpoint device; and
transmit the one or more second SIP messages when it is determined that the IP version that is likely to be used by the media resources of the second endpoint device is not compatible with the IP version that is used by the media resources of first endpoint device.
